(19) United States
(12) Patent Application Publication
(10) Pub. No.: US 2026/0296648 A1
(43) Pub. Date: Oct. 1, 2026

(54) AIRCRAFT GALLEY COMPARTMENT VENTILLATION USING ON-BOARD CONDITIONED AIR SYSTEM

(71) Applicant: EMBRAER S.A., São José dos Campos – SP (BR)

(72) Inventors: Alberto Rodrigues MARTINS, São José dos Campos – SP (BR); Alan Felipe Castilho MAIA, São José dos Campos – SP (BR); Erik Vasconcelos DA SILVA, São José dos Campos – SP (BR); Isabel Veiga DE CARVALHO, São José dos Campos – SP (BR); Marcelo MERZVINSKAS, São José dos Campos – SP (BR); Rodrigo Silva RODRIGUES, São José dos Campos – SP (BR); Samantha Gonzalez TESSELE, São José dos Campos – SP (BR); Thais BORTHOLIN, São José dos Campos – SP (BR); Bhertrand Gabler MAURO GOMES, São José dos Campos – SP (BR)

(21) Appl. No.: 19/089,464

(22) Filed: Mar. 25, 2025

(51) Int. Cl. B64D 13/06; B64D 11/04

(52) U.S. Cl. CPC B64D 13/06; B64D 11/04; B64D 2013/0625

(57) ABSTRACT

Aircraft galley monuments are provided with a ventilated compartment that is configured to being operatively interconnected with an aircraft's on-board environmental control and vent systems. The ventilated compartment of the galley monument may include an inlet air grill configured to allow fresh ventilation air to be introduced into the ventilated compartment and a galley conditioned air conduit connected at one end to the inlet air grill and configured for operative connection at an opposite end thereof to a conditioned air duct of the on-board aircraft cabin environmental control system to direct the fresh ventilation air from the environmental control system to the inlet air grill. Also provided are an outlet vent grill configured to allow air within the ventilated compartment to be discharged therefrom and a vent conduit connected at one end to the outlet vent grill and configured for operative connection at an opposite end thereof to a vent duct to allow air from the ventilated cabinet to be vented to a cabin external environment.

### FIELD

The embodiments disclosed herein relate generally to aircraft galley compartments. In especially preferred forms, the embodiments disclosed herein relate to non-refrigerated galley compartments that may be ventilated and temperature controlled by the on-board conditioned air system of the aircraft.

### BACKGROUND

Thus use of refrigerated galley compartments in aircraft to maintain food and/or beverages in a chilled temperature state is well known. However, the associated refrigeration equipment required to maintain the refrigerated compartments at the desired temperature necessarily reduces the useful compartment space within the galley, thereby in turn reducing the volume of space within the compartment available for storage. Further, conventional refrigerated galley compartments require relatively heavy refrigeration equipment that demand more elaborate interior cabin installations which thereby sometimes require modification of the layout of the galley furniture. Such space and weight penalties are particularly acute for small and medium-sized aircraft.

It would therefore be desirable if aircraft galley compartments could be provided with fresh air in the absence of refrigeration equipment. It is towards fulfilling such a need that the embodiments disclosed herein are directed.

### SUMMARY

Broadly, the embodiments disclosed herein are directed toward aircraft galley monuments having a ventilated compartment that is configured to being operatively interconnected with an aircraft's on-board environmental control and vent systems. As such, the galley monuments in accordance with the disclosed embodiments can avoid the space and weight penalties associated with conventional refrigerated galley monuments. Thus, in accordance with preferred embodiments, the ventilated compartment of the galley monument will include an inlet air grill configured to allow fresh ventilation air to be introduced into the ventilated compartment and a galley conditioned air conduit connected at one end to the inlet air grill and configured for operative connection at an opposite end thereof to a conditioned air duct of the on-board aircraft cabin environmental control system to direct the fresh ventilation air from the environmental control system to the inlet air grill. Also provided are an outlet vent grill configured to allow air within the ventilated compartment to be discharged therefrom and a vent conduit connected at one end to the outlet vent grill and configured for operative connection at an opposite end thereof to a vent duct to allow air from the ventilated cabinet to be vented to a cabin external environment.

A galley air control valve (GCV) may be operatively positioned in the galley conditioned air conduit to regulate the fresh ventilation air introduced into the ventilated compartment. Temperature regulation within the ventilated compartment may thus be controllably maintained by modulation of the GCV. In this regard, a temperature switch may be operatively associated with the conditioned air duct of the on-board aircraft cabin environmental control system to sense temperature of the fresh ventilation air supplied thereby. The temperature switch is therefore positioned in the distribution line to ensure that it receives air flow continuously from the environmental control system (ECS) by a conditioned air duct or cold air from the ECS.

The cabin air temperature range is selected by the crew/passengers at an air conditioning control panel so that the air supplied by the environmental control system varies from about 65 °F (18 °C) to about 84 °F (29 °C). However, in order to supply fresh air to the ventilated compartment, the GCV and its operatively associated temperature switch is used. The temperature switch will therefore automatically command the GCV to close or open the air flow into the ventilated compartment whenever the sensed airflow temperature is greater than about 76 °F (24.44 °C) and lower than about 66 °F (18.9 °C), respectively. In this manner, the ventilated compartment is supplied with fresh air at an appropriate temperature.

These and other aspects and advantages of the present invention will become clearer after careful consideration is given to the following detailed description of the preferred exemplary embodiments thereof.

### BRIEF DESCRIPTION OF ACCOMPANYING DRAWINGS

The disclosed embodiments of the present invention will be better and more completely understood by referring to the following detailed description of exemplary non-limiting illustrative embodiments in conjunction with the drawings of which:

FIG. 1 is an x-ray plan view of an interior aircraft cabin provided with a ventilated conditioned air galley compartment in accordance with an embodiment of the invention;

FIG. 2 is an enlarged front elevation view of the ventilated conditioned air galley as taken along lines 2-2 in FIG. 1; and

FIG. 3 is a rear elevational view of the ventilated conditioned air galley compartment shown in FIG. 2.

### DETAILED DESCRIPTION OF EXEMPLARY EMBODIMENT

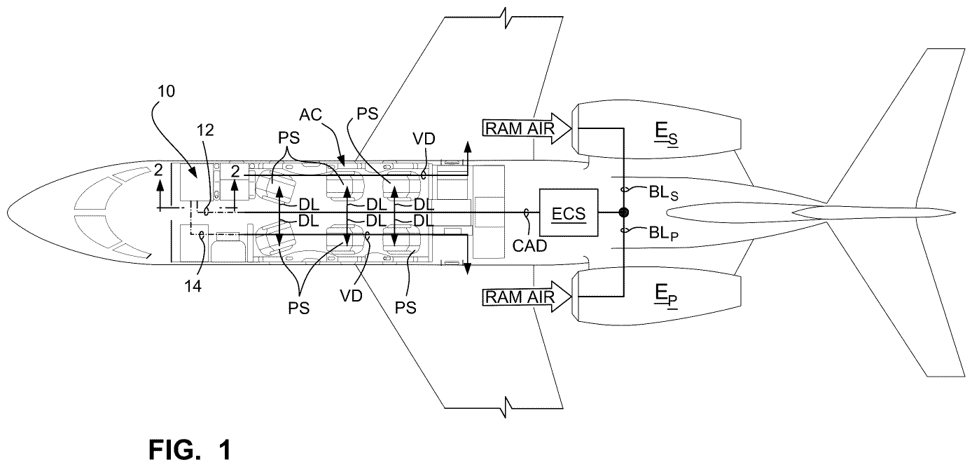

A schematic x-ray plan view of an aircraft cabin AC within an aircraft fuselage which includes a number of passenger seats PS and a galley monument 10 in accordance with an embodiment of the invention is shown in FIG. 1. As is conventional, the aircraft cabin AC includes an on-board environmental control system ECS (colloquially known as an air conditioning pack), which serves to condition and cool bleed air delivered by the port and starboard bleed air lines BLp, BLs from the port and starboard engines Ep, Es, respectively. The bleed air in the bleed air lines BLp, BLs represents a small portion of the ram air entering and used by the engines for the purpose of jet fuel combustion and engine operation and may also be employed by other on-board aircraft systems, e.g., the aircraft's cabin pressurization system.

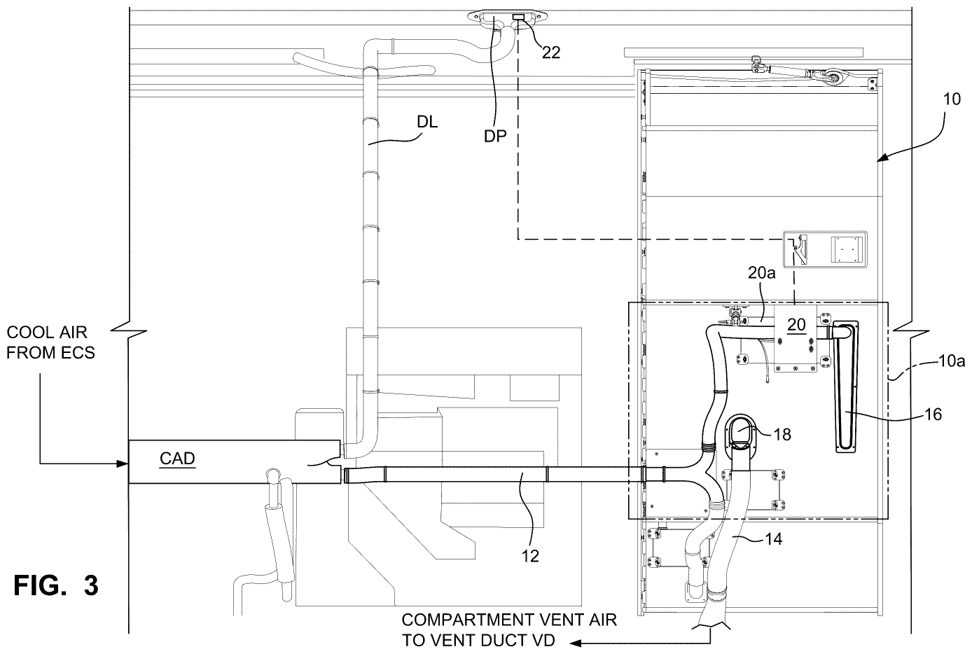

The conditioned and cooled air (e.g., at a temperature of between about 65 °F (18 °C) to about 84 °F (29 °C) as selected by the crew/passengers) is delivered to the interior aircraft cabin AC from the environmental control system ECS by a conditioned air duct CAD and distributed within the interior aircraft cabin AC by a network of overhead distribution lines DL. The distribution lines DL typically terminate at a distribution port DP (see FIG. 3) which are in fluid communication with conventional overhead air gaspers AG (not shown) located in proximity to the individual passenger seats PS and/or at other locations within the interior aircraft cabin AC to allow passenger and/or flight attendant control of the amount and direction of the conditioned air flow delivered by the environmental control system ECS.

The internal cabin air is vented from the interior aircraft cabin AC to the cabin external environment via a vent duct VD to provide a continual exchange of interior cabin air with fresh conditioned air from the environmental control system ECS. Important to the embodiments disclosed herein, the galley monument 10 includes at least one compartment thereof that is operatively connected to the aircraft's on-board conditioned air duct CAD and the vent duct VD by galley conditioned air and vent conduits 12, 14, respectively.

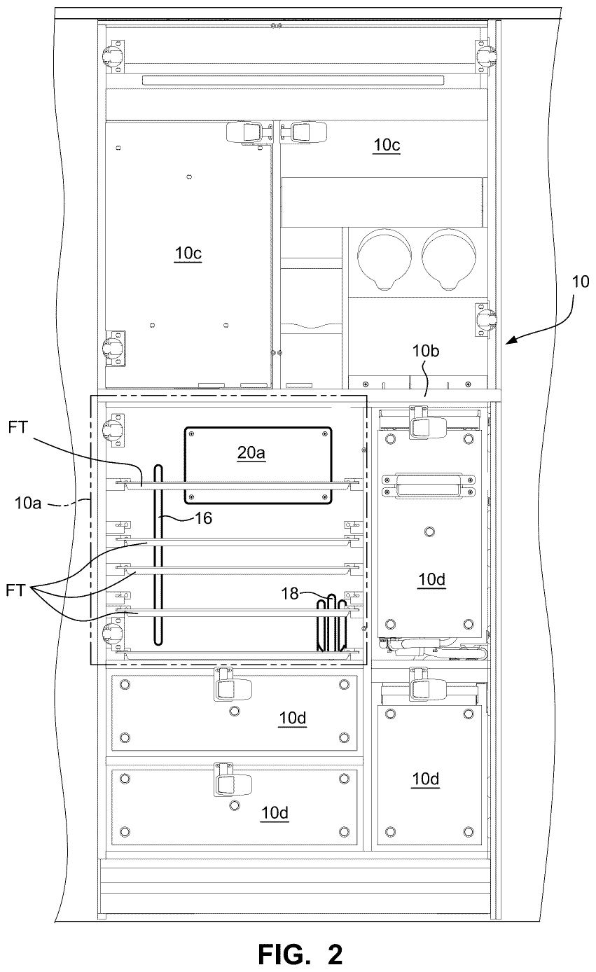

FIGS. 2 and 3 show in greater detail the operational interconnection of the galley monument 10 which includes a ventilated galley compartment 10a. It will be appreciated that the ventilated galley compartment 10a is shown in FIG. 2 as having the door removed so that the internal components thereof are visible. In addition to the ventilated galley compartment 10a, the galley monument 10 may also include a horizontal work surface 10b and upper and lower cabinet compartments and drawers 10c, 10d, respectively.

As is shown especially by FIG. 3, the ventilated galley compartment 10a is operatively interconnected to both the conditioned air duct CAD of the interior aircraft cabin AC providing fresh air from the on-board environmental control system ECS and the vent duct VD associated with the venting system for the interior aircraft cabin AC. As shown, the ventilated galley compartment 10a may contain prepared food trays FT that are required to be stored at a comfortable environmental temperature (e.g., less than about 77 °F (25 °C)). The ventilated galley compartment 10a receives such fresh ventilation air from the galley conditioned air conduit 12 through a vertically elongate inlet air grill 16. Air is vented from the galley compartment 10a through the vent grill 18 and directed by the vent conduit 14 to the aircraft's vent duct VD.

A galley air control valve (GAV) 20 is operatively positioned behind a removable maintenance panel 20a at the rear wall of the ventilated compartment 10a. Removal of the maintenance panel 20a will therefor allow access to the GAV 20 for the purpose of valve maintenance and/or replacement. The GAV 20 is operatively interconnected to a temperature switch 22 which is capable of sensing air temperature from the distribution port DP of the conditioned air distribution line DL. The temperature switch 22 thereby cooperatively issues command signals to the GAV 20 to allow only fresh conditioned air to enter the ventilated compartment 10a via the inlet air grill 16 when the sensed temperature is below the desired setpoint temperature 77° (25 °C), i.e., by closing the GAV to stop the air flow into the ventilated compartment 10 whenever the sensed airflow temperature is greater than 77 °F (25 °C) and opening the GAV to allow fresh air flow into the ventilated compartment 10 whenever the sensed airflow temperature is lower than 67 °F (18.9 °C), respectively.

While reference is made herein to particular embodiments of the invention, various modifications within the skill of those in the art may be envisioned. Therefore, it is to be understood that the invention is not to be limited to the disclosed embodiment, but on the contrary, is intended to cover various modifications and equivalent arrangements included within the spirit and scope thereof.

What is claimed is:

1. An aircraft galley monument comprising a ventilated compartment which includes:
an inlet air grill configured to allow fresh ventilation air to be introduced into the ventilated compartment;
a galley conditioned air conduit connected at one end to the inlet air grill and configured for operative connection at an opposite end thereof to a conditioned air duct of an on-board aircraft cabin environmental control system to direct the fresh ventilation air from the environmental control system to the inlet air grill;
an outlet vent grill configured to allow air within the ventilated compartment to be discharged therefrom; and
a vent conduit connected at one end to the outlet vent grill and configured for operative connection at an opposite end thereof to a vent duct to allow air from the ventilated compartment to be vented to a cabin external environment.

2. The aircraft galley monument according to claim 1, further comprising a galley air control valve (GAV) operatively positioned in the galley conditioned air conduit to regulate the fresh ventilation air introduced into the ventilated compartment.

3. The aircraft galley monument according to claim 2, further comprising:
a temperature switch operatively associated with the conditioned air duct of the on-board aircraft cabin environmental control system to sense temperature of the fresh ventilation air supplied thereby; wherein
the temperature switch issues command signals to the GAV to close or open the GAV in response to sensing a temperature of the fresh ventilation air which is above a predetermined high temperature set point or below a low temperature set point, respectively.

4. The aircraft galley monument according to claim 3, wherein the predetermined high temperature set point is about 76 °F (24.4 °C).

5. The aircraft galley monument according to claim 3, wherein the predetermined low set point temperature is about 66 °F (18.9 °C).

6. The aircraft galley monument according to claim 2, wherein the ventilated compartment further comprises a removable maintenance panel at a rear wall thereof, and wherein the galley control valve is positioned behind the maintenance panel.

7. An aircraft having an interior aircraft cabin and the galley monument according to claim 1 positioned within the interior aircraft cabin.

8. An aircraft comprising:
a fuselage defining an interior cabin;
an environmental control system having a conditioned air duct to provide fresh ventilation air to the interior cabin;
a vent duct to vent the internal cabin air to an external cabin environment; and
a galley monument positioned within the interior cabin, wherein the galley monument comprises a ventilated compartment, wherein the ventilated compartment includes:
(i) an inlet air grill configured to allow the fresh ventilation air to be introduced into the ventilated compartment;
(ii) a galley conditioned air conduit connected at one end to the inlet air grill and connected at an opposite end thereof to the conditioned air duct of the on-board aircraft cabin environmental control system to direct the fresh ventilation air from the environmental control system to the inlet air grill;
(iii) an outlet vent grill configured to allow air within the ventilated compartment to be discharged therefrom; and
(iv) a vent conduit connected at one end to the outlet vent grill and connected at an opposite end thereof to the vent duct to allow air from the ventilated cabinet to be vented to the cabin external environment.

9. The aircraft according to claim 8, wherein the galley monument further comprises a galley air control valve (GAV) operatively positioned in the galley conditioned air conduit to regulate the fresh ventilation air introduced into the ventilated compartment.

10. The aircraft according to claim 9, wherein the galley monument further comprises:
a temperature switch operatively associated with the conditioned air duct of the on-board aircraft cabin environmental control system to sense temperature of the fresh ventilation air supplied thereby, wherein
the temperature switch issues command signals to the GAV to close or open the GAV in response to sensing a temperature of the fresh ventilation air which is above a predetermined high temperature set point or below a low temperature set point, respectively.

11. The aircraft according to claim 10, wherein predetermined high temperature set point is about 76 °F (24.4 °C).

12. The aircraft according to claim 10, wherein the predetermined low set point temperature is about 66 °F (18.9 °C).

13. The aircraft according to claim 9, wherein the ventilated compartment further comprises a removable maintenance panel at a rear wall thereof, and wherein the galley control valve is positioned behind the removable maintenance panel.

14. The aircraft according to claim 8, further comprising a plurality of passenger seats positioned within the interior cabin, wherein the environmental control system includes a plurality of distribution lines fluid connected at one end to the conditioned air duct and having an air distribution point at an opposite end thereof in proximity to the passenger seats.

15. The aircraft according to claim 8, further comprising port and starboard engines, and port and starboard bleed air lines supplying bleed air from the port and starboard engines to the environmental control system.
